(19) United States
(12) Patent Application Publication
(10) Pub. No.: US 2013/0196219 A1
(43) Pub. Date: Aug. 1, 2013

(54) RECHARGEABLE BATTERY

(71) Applicants: Samsung SDI CO., LTD., Yongin-si (KR); Robert Bosch GMBH, Stuttgart (DE)

(72) Inventor: Duk-Jung KIM, Yongin-si (KR)

(73) Assignees: Robert Bosch GMBH, Stuttgart (DE); Samsung SDI CO., LTD., Yongin-si (KR)

(21) Appl. No.: 13/743,413

(22) Filed: Jan. 17, 2013

Related U.S. Application Data
(60) Provisional application No. 61/593,539, filed on Feb. 1, 2012.

(51) Int. Cl. H01M 2/32

(52) U.S. Cl. CPC H01M 2/32
USPC 429/179

(57) ABSTRACT

A rechargeable battery including an electrode assembly including a first electrode and a second electrode; a case accommodating the electrode assembly; a first terminal electrically connected to the first electrode of the electrode assembly; a cap plate on the case, the cap plate being electrically connected to the second electrode of the electrode assembly; and an electron donor, the electron donor being electrically connected to the first terminal.

### CROSS-REFERENCE TO RELATED APPLICATION

The present application claims priority under 35 U.S.C. §119(e) to U.S. Provisional Application No. 61/593,539, filed on Feb. 1, 2012, and entitled: “Rechargeable Battery,” which is incorporated herein by reference in its entirety.

### BACKGROUND

1. Field

Embodiments relate to a rechargeable battery.

2. Description of the Related Art

A rechargeable battery may be repeatedly charged and discharged, unlike a primary battery. A low-capacity rechargeable battery may be used for a small portable electronic device, e.g., a mobile phone, a laptop computer, and/or a camcorder. A large-capacity rechargeable battery may be used as a power supply for driving a motor of, e.g., a hybrid vehicle or the like.

A high power rechargeable battery using a non-aqueous electrolyte having high energy density has been considered. The high power rechargeable battery may be configured by a large-capacity battery module by connecting a plurality of rechargeable batteries in series so as to be used for devices required for large power, e.g., a motor drive of an electric vehicle or the like.

Further, a battery module may be configured by a plurality of rechargeable batteries which may be connected to each other in series, and the rechargeable battery may be formed, e.g., in a cylindrical shape, a square shape, or the like.

The above information disclosed in this Background section is only for enhancement of understanding of the background of the described technology and therefore it may contain information that does not form the prior art that is already known in this country to a person of ordinary skill in the art.

### SUMMARY

Embodiments are directed to a rechargeable battery.

The embodiments may be realized by providing a rechargeable battery including a first electrode and a second electrode; a case accommodating the electrode assembly; a first terminal electrically connected to the first electrode of the electrode assembly; a cap plate on the case, the cap plate being electrically connected to the second electrode of the electrode assembly; and an electron donor, the electron donor being electrically connected to the first terminal.

The rechargeable battery may further include a second terminal electrically connected to the second electrode of the electrode assembly.

The electron donor may include a material having a higher reactivity than a material of the first terminal.

The electron donor may include at least one of magnesium, sodium, zinc, iron, cobalt, and lead.

The first terminal may include one of aluminum and copper.

The first terminal may include a terminal plate and a terminal connection member.

The rechargeable battery may further include an insulation member on the cap plate and coupled with the first terminal, the insulation member being between the terminal plate and the cap plate.

The insulation member may include a bottom plate and a side wall, the bottom plate may be between the terminal plate and the cap plate, and the side wall may extend from a periphery of the bottom plate.

The bottom plate may include a hole therethrough, the terminal connecting portion extending through the hole.

The electron donor may contact a bottom surface of the terminal plate.

The electron donor may be between the bottom surface of the terminal plate and the bottom plate of the insulation member.

The electron donor may include a hole therethrough, the terminal connecting portion extending through the hole.

The electron donor may have a collar shape in contact with a periphery of the terminal plate.

The collar shape of the electron donor may be in the form of a hollow rectangle.

The electron donor may be between the periphery of the terminal plate and the side wall of the insulation member.

The electron donor may include a lower contact portion and a side contact portion, the lower contact portion may have a plate shape corresponding to a shape of the bottom plate of the insulation member, the side contact portion may extend outwardly along sides of the lower contact portion, and the electron donor may be coated on an inner surface of the insulation member.

The lower contact portion may contact a bottom surface of the terminal plate, and the side contact portion may contact a periphery of the terminal plate.

The lower contact portion may be between the bottom surface of the terminal plate and the bottom plate of the insulation member, and the side contact portion may be between the side surface of the terminal plate and the side wall of the insulation member.

The electron donor may include a hole therethrough, the terminal connecting portion extending through the hole.

The electron donor may be a sacrificial electrode that corrodes at a higher rate than the first terminal.

### BRIEF DESCRIPTION OF THE DRAWINGS

Features will become apparent to those of ordinary skill in the art by describing in detail exemplary embodiments with reference to the attached drawings in which:

FIG. 1 illustrates a perspective view of a rechargeable battery according to an embodiment.

FIG. 2 illustrates a cross-sectional view of the rechargeable battery of FIG. 1, taken along the line II-II.

FIG. 3 illustrates an exploded perspective view of an insulation member of the rechargeable battery of FIG. 1.

FIG. 4 illustrates a cut-away perspective view of a part of the rechargeable battery of FIG. 1.

FIG. 5 illustrates an exploded perspective view of an insulation member according to an embodiment.

FIG. 6 illustrates a cut-away perspective view of a part of a rechargeable battery according to an embodiment.

FIG. 7 illustrates an exploded perspective view of an insulation member according to an embodiment.

FIG. 8 illustrates a cur-away perspective view of a part of a rechargeable battery according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when a element is referred to as being “between” two elements, it can be the only element between the two elements, or one or more intervening elements may also be present. Like reference numerals refer to like elements throughout.

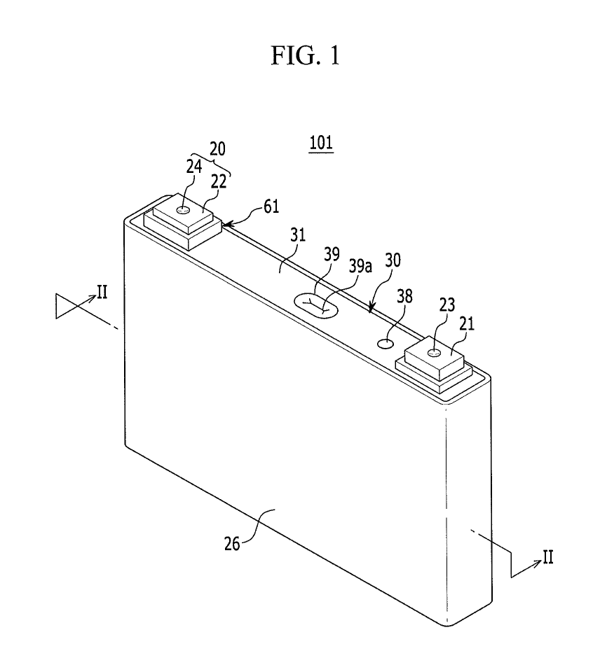

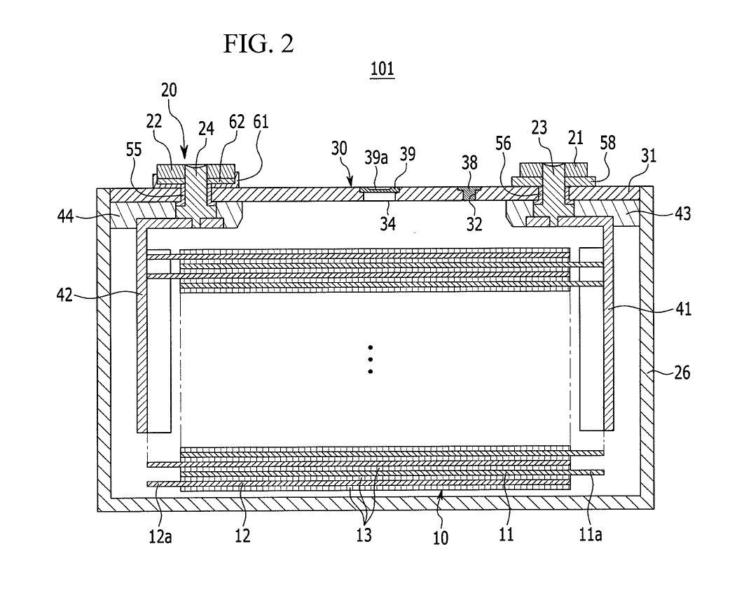

FIG. 1 illustrates a perspective view of a rechargeable battery according to an embodiment. FIG. 2 illustrates a cross-sectional view of the rechargeable battery of FIG. 1, taken along the line II-II.

Referring to FIG. 1 and FIG. 2, a rechargeable battery 101 according to an embodiment may include an electrode assembly 10 (formed by winding a second, e.g., positive, electrode 11 and a first, e.g., negative, electrode 12 with a separator 13 therebetween), a case 26 (in which the electrode assembly 10 is installed or accommodated), and a cap assembly 30 (coupled with the case 26 at, e.g., an opening of the case 26.

The rechargeable battery 101 according to the present embodiment may be a lithium ion rechargeable battery having a prismatic or hexahedral shape. However, the embodiments are not limited thereto, and the rechargeable battery 101 may be lithium polymer battery, a cylindrical battery, or the like.

The positive electrode 11 and the negative electrode 12 may include coated regions (where an active material is coated to a current collector formed of a thin metal foil) and uncoated regions 11a and 12a (where the active material is not coated). The positive electrode uncoated region 11a may be at a first side end of the positive electrode 11 along a length direction of the positive electrode 11, and the negative uncoated region 12a may be at a second side end of the negative electrode 12 along a length direction of the negative electrode 12. The positive electrode 11 and the negative electrode 12 may be spirally wound, interposing the separator 13 therebetween. In an implementation, the separator 13 may be an insulator.

In an implementation, the electrode assembly 10 may have a structure where a positive electrode and a negative electrode, each formed of a plurality of sheets are alternately layered, interposing a separator therebetween.

The case 26 may have an approximately cuboid or hexahedral shape, and an opening may be formed at one side thereof. The case 26 may be formed of metal, e.g., aluminum and stainless steel.

The cap assembly 30 may include, e.g., a cap plate 31 (covering the opening of the case 26), a second, e.g., positive, terminal 21 (protruding toward an outer side of the cap plate 31 and electrically connected with the positive electrode 11), and a first, e.g., negative, terminal 20 (protruding toward an outer side of the cap plate 31 and electrically connected to the negative electrode 12). The negative terminal 20 may include a terminal plate 22 and a terminal connecting member 24.

The cap plate 31 may be formed of a long plate extended in one direction, and may be coupled with the case 26, e.g., at the opening of the case 26. The cap plate 31 may include a sealing cap 38 and a vent plate 39. The sealing cap 38 may be installed in an electrolyte injection opening 32, and the vent plate 39 may have a notch 39a in a vent hole 34, the notch 39a being breakable in response to a predetermined internal pressure. In an implementation, the cap plate 31 may be electrically connected to the positive electrode 11 of the electrode assembly 10.

The positive terminal 21 and the negative terminal 20 may protrude in an upward direction of the cap plate 31. The positive terminal 21 may be electrically connected to the positive electrode 11 through a current collecting tab 41, and the negative terminal 20 may be electrically connected to the negative electrode 12 through a current collecting tab 42.

A terminal connection member 23 (electrically connecting the positive terminal 21 and the current collecting tab 41) may be provided between the positive terminal 21 and the current collecting tab 41. The positive terminal 21 and the terminal connection member 23 may be formed of aluminum, e.g., a same material as a positive electrode current collector (not illustrated).

The terminal connection member 23 may be inserted to a hole in the positive terminal 21. Thus, an upper end of the terminal connection member 23 may be fixed to the positive terminal 21 by welding, and a lower end of the terminal connection member 23 may be fixed to the current collecting tab 41 by welding.

A gasket 56 may be inserted into a hole through which the terminal connection member 23 penetrates between the terminal connection member 23 and the cap plate 31 for sealing therebetween. A lower insulation member 43 (to which a lower portion of the terminal connection member 23 is inserted) may be provided under the cap plate 31.

A connection plate 55 (that electrically connects the positive terminal 21 and the cap plate 31) may be provided on the positive terminal 21. The terminal connection member 23 may be inserted into the connection plate 55. The connection plate 55 may be approximately formed in the shape of a rectangular plate. Accordingly, the cap plate 31 and the case 26 may be charged with, e.g., may have the same polarity as, the positive electrode 11.

As described above, the negative terminal 20 may include the terminal plate 22 and the terminal connection member 24. The terminal connection member 24 may be provided between the terminal plate 22 and the current collecting tab 42 for electrical connection therebetween. The terminal connection member 24 may be inserted into a hole formed in the terminal plate 22. Thus, an upper end of the terminal connection member 24 may be fixed to the terminal plate 22 by welding, and a lower end of the terminal connection member 24 may be fixed to the current collecting tab 42 by welding. In an implementation, the terminal plate 22 may be formed of aluminum, and the terminal connection member 24 may be formed of copper, e.g., a same material of a negative electrode current collector (not illustrated).

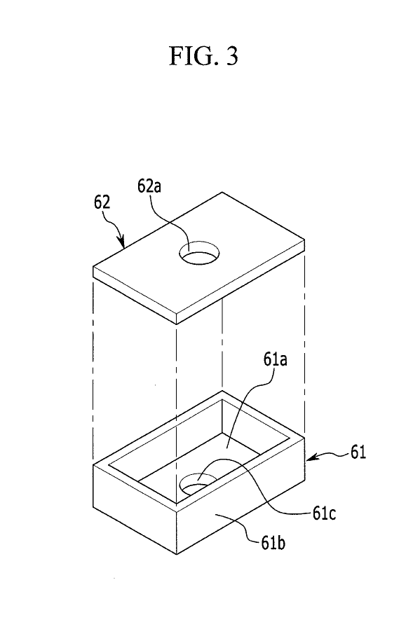

As shown in FIG. 3, the terminal connection member 24 may include a column portion 24a, a lower flange 24b, and a lower protrusion 24c. The column portion 24a may penetrate the cap plate 31 and an upper end thereof may contact the terminal plate 22 and thus be fixed thereto. The lower flange 24b may protrude at sides of a lower end of the column portion 24a. The lower protrusion 24c may protrude downwardly from the lower end of the column portion 24a, may be inserted to the current collecting tab 42, and may then be fixed thereto by welding. A gasket 58 may be provided between the negative terminal 20 and the cap plate 31 for sealing therebetween. A lower insulation member 44 may be provided under the cap plate 31 for insulating the negative terminal 20 and the current collecting tab 42 from the cap plate 31.

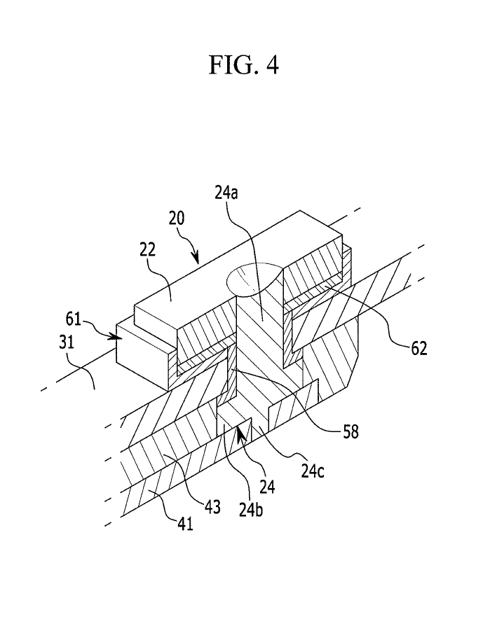

FIG. 3 illustrates an exploded perspective view of an insulation member of the rechargeable battery of FIG. 1. FIG. 4 illustrates a cut-away perspective view of a part of the rechargeable battery of FIG. 1.

Referring to FIG. 3 and FIG. 4, an insulation member 61 may be provided between the negative terminal 20, e.g., the terminal plate 22, and the cap plate 31 for insulation therebetween. In addition, an electron donor 62 may be provided. The insulation member 61 may insulate between the negative terminal 20 and the cap plate 31. The electron donor 62 may contact the negative terminal 22, e.g., may be electrically connected to the terminal plate 22.

The insulation member 61 may include a bottom plate 61a and a side wall 61b. The side wall 61b may extend to an upper portion of the bottom plate 61a from a side end of the bottom plate 61a. For example, the side wall 61b may extend from a periphery of the bottom plate 61a. In an implementation, the bottom plate 61a may have an approximately quadrangular plate shape, and the side wall 61b may extend to an upper portion thereof from four side ends of the bottom plate 61a. The bottom plate 61a may include a hole 61c to or through which the terminal connection member 24 is inserted. With such a structure, the insulation member 61 may have a cuboid shape having an opened upper portion.

The terminal plate 22 may be inserted into the insulation member 61 through the opened upper portion of the insulation member 61 and thus may contact the electron donor 62.

The electron donor 62 may have a quadrangular plate shape corresponding to a shape of the insulation member 61. The electron donor 62 may provide electrons to the negative terminal 20. A hole 62a (to or through which the terminal connection member 24 is inserted) may be formed in a center of the electron donor 62. The electron donor 62 may be provided between the bottom plate 61a and a bottom side of the terminal plate 22 and thus may contact the terminal plate 22. The electron donor 62 may be attached to a bottom of the insulation member 61. Thus, the electron donor 62 may be provided between the bottom side of the terminal plate 22 and the bottom plate 61a.

The electron donor 62 may be formed of a material having stronger or higher reactivity than the terminal plate 22. When the cap plate 31 and the case 26 are positively charged, electrons of the negative terminal 20 may move to the cap plate 31, and thus the negative terminal 20 may be oxidized. When oxidation and corrosion occurs in the negative terminal 20, contact resistance between the negative terminal 20 and another member contacting the negative terminal 20 may be increased so that performance of the rechargeable battery may be deteriorated.

The electron donor 62 may be formed of a material having a higher ionization tendency than the terminal plate 22, and electrons may be provided to the negative terminal 20 from the electron donor 62. Thus, the electron donor 62 may help prevent oxidation and corrosion from occurring in the negative terminal 20.

For example, the electrons (which are provided to negative terminal 20 from the electron donor 62) may move to the cap plate 31 (which may be positively charged). Thus, a number of the electrons in the negative terminal 20 may not decrease and corrosion in the negative terminal 20 by the decrease of the number of the electrons in the negative terminal 20 may be reduced and/or prevented.

As described above, the electron donor 62 may be formed of the material having a higher ionization tendency than the terminal plate 22 to help prevent the corrosion in the negative terminal 20. Accordingly, the electron donor 62 may be formed of a material having fewer valence electrons than the terminal plate 22 and having more electron shells than the terminal plate 22.

If the material forming the electron donor 62 (having fewer valence electrons than the terminal plate 22 and having more electron shells than the terminal plate 22), outermost electrons of the electron donor 62 may easily move to the negative terminal 20, because an energy to ionize outermost electrons of the electron donor 62 may be smaller than an energy to ionize outermost electrons of the terminal plate 22.

When the terminal plate 22 is formed of aluminum, the electron donor 62 may be formed of a material having higher reactivity than the terminal plate 22. In an implementation, the material having higher reactivity than the terminal plate 22, i.e., the material for forming the electron donor 62, may include, e.g., magnesium and/or sodium. In an implementation, the material for forming the electron donor 62 may include, e.g., magnesium, sodium, zinc, iron, cobalt, and/or lead. In an implementation, the first terminal 20 may include, e.g., aluminum and/or copper.

However, in a rechargeable battery including the electron donor 62 according to an embodiment, electrons may move to the negative terminal 20 from the electron donor 62. Thus, a number of electrons in the negative terminal 20 may not decrease. Therefore, oxidation of the negative terminal 20 may be prevented, and the electron donor 62 may be oxidized instead of the negative terminal 20.

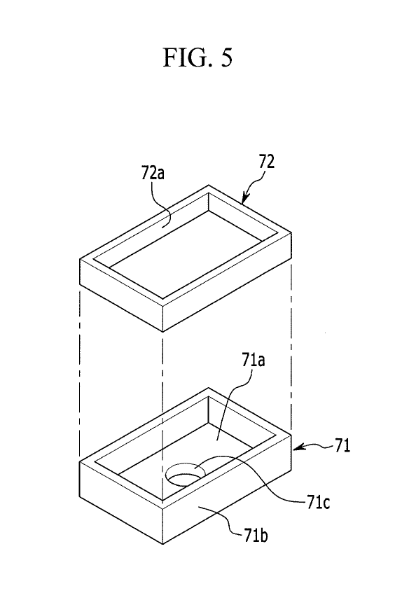

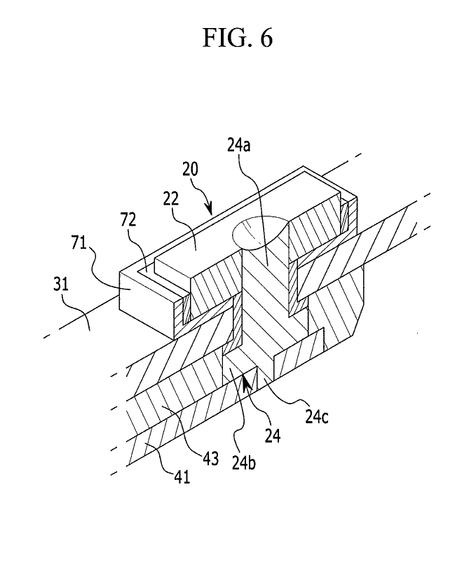

FIG. 5 illustrates an exploded perspective view of an insulation member according to an embodiment. FIG. 6 illustrates a cut-away perspective view of a part of a rechargeable battery according to an embodiment.

Referring to FIG. 5 and FIG. 6, an insulation member 71 may be provided between a negative terminal 20 and a cap plate 31 for insulation therebetween.

The rechargeable battery according to the present embodiment may be the same as the rechargeable battery according to the previous embodiment, except for a structure of the insulation member 71. Accordingly, repeated detailed descriptions of the same structure may be omitted.

The insulation member 71 may insulate between the negative terminal 20 and the cap plate 31. In addition, an electron donor 72 may be provided. The electron donor 72 may contact the negative terminal 20, e.g., may be electrically connected to the terminal plate 22.

The insulation member 71 may include a bottom plate 71a and a side wall 71b. The side wall 71b may extend to an upper portion of the bottom plate 71a from a side end of the bottom plate 71a. For example, the side wall 71b may extend from a periphery of the bottom plate 71a. In an implementation, the bottom plate 71a may have an approximately quadrangular plate shape, and the side wall may extend to an upper portion thereof from four side ends of the bottom plate 71a. The bottom plate 71a may include a hole 71a to or through which the terminal connection member 24 is inserted. With such a structure, the insulation portion 71 is formed in the shape of a cuboid having an opened upper portion.

The terminal plate 22 may be inserted into the insulation member 71 through the opened upper portion of the insulation member 71 and thus may contact the electron donor 72.

The electron donor 72 may have a cross section of a rectangular ring shape. The electron donor 72 may provide electrons to the negative terminal 20. The electron donor 72 may be attached to or coupled with the side wall 71b of the insulation member 71 and may be between the side surface of the terminal plate 22 and the side wall 71b. For example, the electron donor 72 may have a collar shape in contact with a periphery of the terminal plate 22. In an implementation, the collar shape of the electron donor 72 may be in the form of a hollow rectangle. In an implementation, the electron donor 72 may be between the periphery of the terminal plate 22 and the side wall 71b of the insulation member 71.

The electron donor 72 may be formed of a material that is much more oxidizable, e.g., having a stronger reactivity, than the terminal plate 22. For example, the electron donor 72 may be formed of a material having fewer valence electrons than the terminal plate 22 and having more electron shells than the terminal plate 22.

When the terminal plate 22 is formed of aluminum, the electron donor 72 may be formed of a material much more oxidizable or reactive than the terminal plate 22. The material may include magnesium and/or sodium.

When the electron donor 72 is formed of the material that is much more oxidizable or reactive than the terminal plate 22, the electron donor 72 may provide electrons to the negative terminal 20 to help minimize oxidization of the negative terminal 20.

When the cap plate 31 and the case 26 are positively charged, electrons of the negative terminal 20 may move to the cap plate 31 and the negative terminal 20, e.g., the terminal plate 22, may be oxidized. When the negative terminal 20 oxidizes, contact resistance between the negative terminal 20 and another member contacting the negative terminal 20 may be increased, thereby deteriorating performance of the rechargeable battery.

However, when the insulation member 71 and the electron donor 72 is included in the rechargeable battery, corrosion of the negative terminal 20 may be reduced and/or prevented by providing electrons to the negative terminal 20 such that the electron donor 72 is corroded instead of the negative terminal 20. For example, the electron donor 72 may be a sacrificial electrode that corrodes at a higher rate than the first or negative terminal 20, e.g., than the terminal plate 22.

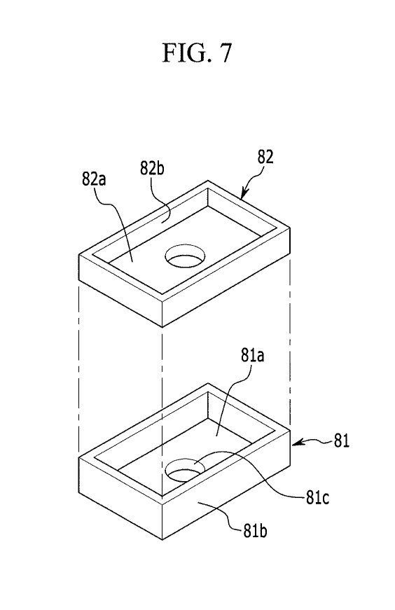

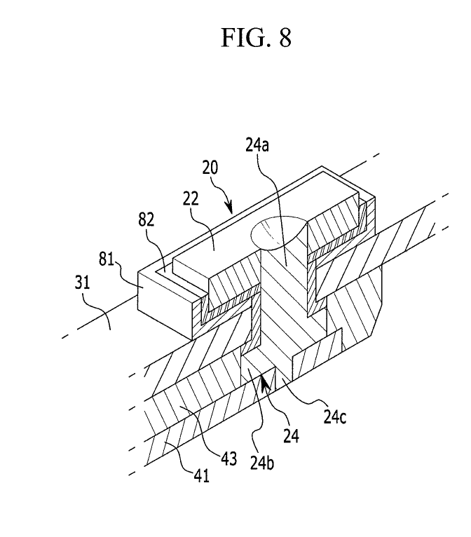

FIG. 7 illustrates an exploded perspective view of an insulation member according to an embodiment. FIG. 8 illustrates a cur-away perspective view of a part of a rechargeable battery according to an embodiment.

Referring to FIG. 7 and FIG. 8, an insulation member 81 may be provided between a negative terminal 20 and a cap plate 31 for insulation therebetween. The rechargeable battery according to the present embodiment may be the same as the rechargeable battery according to the previous embodiments, except for a structure of the insulation member 81. Accordingly, repeated descriptions of the same structures may be omitted.

The insulation member 81 may insulate between the negative terminal 20 and the cap plate 31. The rechargeable battery may also include an electron donor 82. The electron donor 82 may contact the negative terminal 20, e.g., may contact the terminal plate 22.

The insulation member 81 may include a bottom plate 81a and a side wall 81b. The side wall 81b may extend to an upper portion of the bottom plate 81a from a side end of the bottom plate 81a. For example, the side wall 81b may extend from a periphery of the bottom plate 81a. In an implementation, the bottom plate 81a may have an approximately quadrangular plate shape, and the side wall 81b may extend to an upper portion thereof from four side ends of the bottom plate 81a. The bottom plate 81a may include a hole 81c to or through which the terminal connection member 24 is inserted. With such a structure, the insulation member 81 may have a cuboid shape having an opened upper portion.

The terminal plate 22 may be inserted into the insulation member 81 through the opened upper portion of the insulation member 81 and thus may contact the electron donor 82.

The electron donor 82 may include a lower contact portion 82a and a side contact portion 82b protruding to an upper portion from a side end of the lower contact portion 82a. The lower contact portion 82a may have an approximately quadrangular plate shape. For example, the lower contact portion 82a may have a plate shape corresponding to a shape of the bottom plate 81a of the insulation member 81. The side contact portion 82b may extend to an upper portion from four side ends of the lower contact portion 82a. For example, the side contact portion 82b may extend outwardly along sides of the lower contact portion 82a. In an implementation, the electron donor 82 may be coated on an inner surface of the insulation member 81. The lower contact portion 82a may include a hole 82c to or through which the terminal connection member 24 is inserted. In an implementation, the lower contact portion 82a may contact the bottom surface of the terminal plate 22 and the side contact portion 82b may contact a periphery of the terminal plate 22.

The electron donor 82 may be inserted into the insulation portion 81 and thus may be disposed between the terminal plate 22 and the insulation member 81. The lower contact portion 82a may contact a bottom side of the negative terminal 20, and the side contact portion 82b may contact a side of the terminal plate 22. For example, the lower contact portion 82a may contact a bottom surface of the terminal plate 22 of the negative terminal 20, and the side contact portion 82b may contact a periphery of the terminal plate 22. In an implementation, the lower contact portion 82a may be between the bottom surface of the terminal plate 22 and the bottom plate 81a of the insulation member 81, and the side contact portion 82b may be between the side surface of the terminal plate 22 and the side wall 81b of the insulation member 81.

The electron donor 82 may have a cuboid shape having an opened upper portion. In an implementation, the electron donor 82 may be formed by coating metal that forms the electron donor 82 on a surface of the insulation member 81.

As described above, according to the present embodiment, the electron donor 82 may be simply formed by forming the insulation member 81 and coating a sacrificial electrode (e.g., anode) metal on an inner surface of the insulation member 81.

The electron donor 82 may be formed of a material that is much more reactive and/or oxidizable than the terminal plate 22. For example, the electron donor 82 may be formed of a material having fewer valence electrons than the terminal plate 22 and/or a material having more electron shells than the terminal plate 22.

When the terminal plate 22 is formed of aluminum, the electron donor 82 may be formed of a material having higher reactivity than the terminal plate 22. For example, the material for forming the electron donor 82 may include magnesium and/or sodium.

When the electron donor 82 is formed of the material having higher reactivity than the terminal plate 22, the electron donor 82 may provide electrons to the negative terminal 20 to help minimize oxidization of the negative terminal 20.

When the cap plate 31 and the case 26 is positively charged, electrons of the negative terminal 20 may move to the cap plate 31 so that the negative terminal 20 may be oxidized. When the negative terminal 20 oxidizes and/or corrodes, contact resistance between the negative terminal 20 and another member contacting the negative terminal 20 may be increased. Thus, performance of the rechargeable battery may be deteriorated.

However, when the insulation member 81 and the electron donor 82 are provided, the electron donor 82 may provide electrons to the negative terminal 20 to help reduce and/or prevent corrosion of the negative terminal 20. For example, the electron donor 82 may be corroded instead of the negative terminal 20.

By way of summation and review, when the case of the rechargeable battery is positively charged, electrons may be separated from the negative terminal, thereby causing corrosion of the negative terminal. When the negative terminal is corroded, contact resistance between the negative terminal and a member connected to the negative terminal may be increased so that the performance of the rechargeable battery may be deteriorated.

The embodiments provide a rechargeable battery that helps prevent corrosion of a negative terminal. The embodiments provide a rechargeable battery having an improved insulation member.

According to an embodiment, reactivity of the electron donor may be higher than that of the terminal plate of the negative terminal. Thus, the electron donor may provide electrons to the negative terminal to help prevent oxidization of the negative terminal.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
an electrode assembly including a first electrode and a second electrode;
a case accommodating the electrode assembly;
a first terminal electrically connected to the first electrode of the electrode assembly;
a cap plate on the case, the cap plate being electrically connected to the second electrode of the electrode assembly; and
an electron donor, the electron donor being electrically connected to the first terminal.

2. The rechargeable battery as claimed in claim 1, further comprising a second terminal electrically connected to the second electrode of the electrode assembly.

3. The rechargeable battery as claimed in claim 1, wherein the electron donor includes a material having a higher reactivity than a material of the first terminal.

4. The rechargeable battery as claimed in claim 3, wherein the electron donor includes at least one of magnesium, sodium, zinc, iron, cobalt, and lead.

5. The rechargeable battery as claimed in claim 4, wherein the first terminal includes one of aluminum and copper.

6. The rechargeable battery as claimed in claim 1, wherein the first terminal includes a terminal plate and a terminal connection member.

7. The rechargeable battery as claimed in claim 6, further comprising an insulation member on the cap plate and coupled with the first terminal, the insulation member being between the terminal plate and the cap plate.

8. The rechargeable battery as claimed in claim 7, wherein:
the insulation member includes a bottom plate and a side wall,
the bottom plate is between the terminal plate and the cap plate, and
the side wall extends from a periphery of the bottom plate.

9. The rechargeable battery as claimed in claim 8, wherein the bottom plate includes a hole therethrough, the terminal connecting portion extending through the hole.

10. The rechargeable battery as claimed in claim 8, wherein the electron donor contacts a bottom surface of the terminal plate.

11. The rechargeable battery as claimed in claim 10, wherein the electron donor is between the bottom surface of the terminal plate and the bottom plate of the insulation member.

12. The rechargeable battery as claimed in claim 8, wherein the electron donor includes a hole therethrough, the terminal connecting portion extending through the hole.

13. The rechargeable battery as claimed in claim 8, wherein the electron donor has a collar shape in contact with a periphery of the terminal plate.

14. The rechargeable battery as claimed in claim 13, wherein the collar shape of the electron donor is in the form of a hollow rectangle.

15. The rechargeable battery as claimed in claim 14, wherein the electron donor is between the periphery of the terminal plate and the side wall of the insulation member.

16. The rechargeable battery as claimed in claim 8, wherein:
the electron donor includes a lower contact portion and a side contact portion,
the lower contact portion has a plate shape corresponding to a shape of the bottom plate of the insulation member,
the side contact portion extends outwardly along sides of the lower contact portion, and
the electron donor is coated on an inner surface of the insulation member.

17. The rechargeable battery as claimed in claim 16, wherein:
the lower contact portion contacts a bottom surface of the terminal plate, and
the side contact portion contacts the periphery of the terminal plate.

18. The rechargeable battery as claimed in claim 17, wherein:
the lower contact portion is between the bottom surface of the terminal plate and the bottom plate of the insulation member, and
the side contact portion is between a side surface of the terminal plate and the side wall of the insulation member.

19. The rechargeable battery as claimed in claim 16, wherein the electron donor includes a hole therethrough, the terminal connecting portion extending through the hole.

20. The rechargeable battery as claimed in claim 1, wherein the electron donor is a sacrificial electrode that corrodes at a higher rate than the first terminal.
